(19) United States
(12) Patent Application Publication
(10) Pub. No.: US 2018/0233851 A1
(43) Pub. Date: Aug. 16, 2018

(54) Electrical Connector

(71) Applicant: Renier SWANEPOEL, Upington (ZA)

(72) Inventors: Renier Swanepoel, Upington (ZA); Jacobus Abraham Myburgh, Upington (ZA); Conleth Costigan, Strand (ZA)

(21) Appl. No.: 15/750,911

(22) PCT Filed: Aug. 4, 2016
(86) PCT No.: PCT/ZA2016/000019

§ 371 Date: Feb. 7, 2018

(30) Foreign Application Priority Data
Aug. 7, 2015 (ZA) 2015/05763

(51) Int. Cl. H01R 13/625; H01R 13/443; H01R 13/64

(52) U.S. Cl. CPC H01R 13/625; H01R 24/86; H01R 13/64; H01R 13/443

(57) ABSTRACT

This invention relates to an electrical connector (110). More specifically, the invention relates to a twist-lock electrical plug and socket connector for use in, amongst others, towing applications where a towed vehicle and a towing vehicle need to be electrically connected to one another. The electrical connector (110) includes a plug body (120), a socket body (132) to which the plug body (120) is connectible, a first locking body (142) comprising first locking formations (144) and being movably mounted on the plug body (120), and a second locking formation (146) on the socket body (132). Typically, the first or the second locking (144, 146) formation extends axially from the respective plug and socket bodies (120, 132) in the direction of respective first connecting ends thereof, and comprise free ends having a radially inwardly extending locking overhangs. Generally, the other of the first or the second locking formation (144, 146) is a protrusion extending radially from the other of the respective plug or socket body (120, 132) and at least partially about the circumference thereof, the radial protrusion having a first surface facing the first connecting and a second oppositely facing surface, such that with the plug and socket bodies (120, 132) connected and with the locking overhang extending beyond the radial protrusion, a twist action imparted between the first locking body (142) and the connected plug and socket bodies (120, 132) causes the locking overhang to engage the second surface of the radial protrusion thereby locking the connected plug and socket bodies (120, 132) to one another.

### BACKGROUND OF THE INVENTION

THIS invention relates to an electrical connector. More specifically, the invention relates to a twist-lock electrical plug and socket connector for use in, amongst others, towing applications where a towed vehicle (i.e. a caravan or trailer) and a towing vehicle (i.e. an automobile) need to be electrically connected to one another.

Electrical plug and socket connectors for towing applications are well known. The most popular comprises a plug on the towed vehicle and a socket on the towing vehicle, with the socket including a weather cover hingedly movable over the socket between open and closed conditions, typically biased towards the latter.

In the closed condition, the weather cover closes the socket and protects it from the elements. In the open condition, the socket is accessible for plugging the plug there into. The weather cover generally comprises a claw like formation on a free end thereof that is adapted to engage with the plug thereby to retain the plug in the socket.

Unfortunately over prolonged use, the weather covers tend to break off the socket. Most users, instead of replacing the socket, continue using them in this broken form. In use, the plugs typically work themselves loose from the broken sockets dangerously cutting off electrical power to the taillights of the towed vehicle. Also, the plugs end up becoming damaged from being dragged along the tarmac.

It is an object of the present invention to provide an electrical plug and socket connector having robust twist-lock formations that address the shortcomings of the known prior art connectors.

### SUMMARY OF THE INVENTION

According to the invention there is provided an electrical connector including:
a plug body having a first connecting end, a second end and a central axis extending through such first and second ends, wherein the plug body houses a first electrical connector therein that is located nearer the first connecting end than to the second end of the plug body;
a socket body having a first connecting end, a second end and a central axis extending through such first and second ends, wherein the socket body houses a second electrical connector therein that is located nearer the first connecting end than to the second end of the socket body such that the first connecting ends of the plug and socket bodies are co-axially engageable with one another to bring the first and second electrical connectors into electrical connection with one another in a connected condition;
a first locking body movably mounted on the plug body or the socket body, the first locking body having at least a first locking formation defined thereon; and
at least a second locking formation on the other of the plug body or the socket body, wherein:
   (i) the first or the second locking formation extends axially from the respective plug or socket body in the direction of the first connecting end thereof, and comprises a free end having a radially inwardly extending locking overhang; and
   (ii) the other of the first or the second locking formation is a protrusion extending radially from the other of the respective plug or socket body and at least partially about the circumference thereof, the radial protrusion having a first surface facing the first connecting end and a second oppositely facing surface;
such that in the connected condition and with the locking overhang extending beyond the radial protrusion, a twist action imparted between the first locking body and the connected plug and socket bodies causes the locking overhang to engage the second surface of the radial protrusion thereby locking the connected plug and socket bodies to one another.

The first electrical connector or the second electrical connector may be made of one or more electrical prongs, and the other of the first electrical connector or the second electrical connector may be made up of one or more electrical prong receiving holes in which the electrical prongs are receivable.

Generally, the first electrical connector and the second electrical connector are each made up of a combination of electrical prongs and electrical prong receiving holes in which the electrical prongs are receivable.

Typically, the electrical prongs and the electrical prong receiving holes are arranged about the central axis of the respective plug and socket bodies in a substantially circular configuration.

Preferably, at least the first connecting end of the plug body is substantially tubular with a second end thereof defining an aperture through which a wire cable comprising a plurality of individual wires is receivable into the plug body, the individual wires being connectible to the respective electrical prongs and/or electrical prong receiving holes of the first electrical connectors.

More preferably, at least the first connecting end of the socket body is tubular with a second end thereof comprising mounting formations for mounting the socket body to an object. It will be appreciated that the second end of the socket body is adapted to enable a wire cable to pass there through thereby to connect individual wires thereof to the respective electrical prongs and/or electrical prong receiving holes of the second electrical connectors.

The mounting formations may be a plurality of apertures each sized and shaped for receiving a fastener there through for fastening the socket body to the object.

Generally, the first locking body is ring shaped and captured near a first connecting end of the plug or the socket body, the first locking body being axially and rotatably movable relative to the plug or the socket body.

Typically, the first locking formation is a combination of:
(i) at least a pair of axially extending primary locking posts located on the first locking body substantially diametrically opposite one another, wherein free ends of the primary locking posts comprise radially inwardly extending locking overhangs; and
(ii) at least a pair of radially extending primary locking protrusions located on the first locking body substantially diametrically opposite one another, each being substantially adjacent one of the respective primary locking posts and having a first surface facing the first connecting end and a second oppositely facing surface.

Preferably, the primary locking posts are three primary locking posts spaced angularly with respect to one another by about 120 degrees. Similarly, the primary locking protrusions are preferably three primary locking protrusions spaced angularly with respect to one another by about 120 degrees.

Generally, the second locking formation is a combination of:
(i) at least a pair of axially extending secondary locking posts located on the other of the plug or the socket body substantially diametrically opposite one another, wherein free ends of the secondary locking posts comprise radially inwardly extending locking overhangs; and
(ii) at least a pair of radially extending secondary locking protrusions located on the same body as the body on which the secondary locking posts are located, the secondary locking protrusions being substantially diametrically opposite one another with each being substantially adjacent one of the respective secondary locking posts and having a first surface facing the first connecting end and a second oppositely facing surface;
   such that in the connected condition and with a twist action imparted between the first locking body and the connected plug and socket bodies, the locking overhangs of the primary locking posts engage the second surfaces of the secondary locking protrusions whereas the locking overhangs of the secondary locking posts engage the second surfaces of the primary locking protrusions thereby to lock the connected plug and socket bodies to one another.

Preferably, the secondary locking posts are three secondary locking posts spaced angularly with respect to one another by about 120 degrees. Similarly, the secondary locking protrusions are preferably three secondary locking protrusions spaced angularly with respect to one another by about 120 degrees.

More preferably, the first locking body is located on the plug socket and the second locking formation is located on the socket body.

The primary and the secondary locking posts together with the respective overhangs thereof are generally r-shaped or c-shaped claws in a plane parallel to the central axes of the plug and socket bodies, and further wherein the free ends of the secondary locking posts extend axially beyond the first connecting end of the socket body.

Generally, the second locking formation is defined on a second ring-shaped locking body located near the first connecting end of the socket body.

Typically, the second locking body is substantially the same as the first locking body and fixed in position at the first connecting end of the socket body

Preferably, at least portions of the second surfaces of the primary and secondary locking protrusions taper towards the first connecting end of the respective plug or socket body such that the twist action operatively imparted thereon causes the plug and socket bodies to be axially drawn toward one another.

The plug body and/or the socket body may comprise a seal member therein for in the connected condition sealing an internal cavity co-operatively formed by the connected plug and socket bodies from an outer environment.

Generally, the plug body is a male connector and the socket body is a female connector, the male plug body being at least partially insertable into the female socket body in the connected condition.

In a preferred embodiment of the invention, dust caps are engageable with the first connecting ends of the each of the plug and socket bodies in a condition other than the connected condition.

Typically, the plug and socket bodies comprise correspondingly engageable locating formations for locating such bodies relative to one another in a single orientation such that the correct electrical prongs engage the correct prong receiving apertures.

### BRIEF DESCRIPTION OF THE DRAWINGS

The invention will now be described in more detail, by way of example only, with reference to the accompanying drawings in which:

FIG. 1 is a perspective view of a plug body and a socket body of an electrical connector in accordance with the present invention, each of the bodies being depicted in assembled conditions;

FIG. 2 is a perspective view of the plug and the socket bodies of FIG. 1, depicted in exploded conditions;

FIG. 3 is a perspective view of the socket body of FIG. 1 mounted to a vehicle, with the plug body extending from a towed vehicle being moved into axial engagement with the socket body;

FIG. 4 is perspective view of the vehicle mounted socket body of FIG. 3 with the plug body connected and locked thereto;

FIG. 5 is a perspective view of a plug body and a socket body of an alternative embodiment of an electrical connector in accordance with the present invention; and

FIG. 6 is a perspective view of the socket body of FIG. 5 with a dust cap closing off a first connecting end of the socket body in an unconnected condition.

### DETAILED DESCRIPTION OF THE DRAWINGS

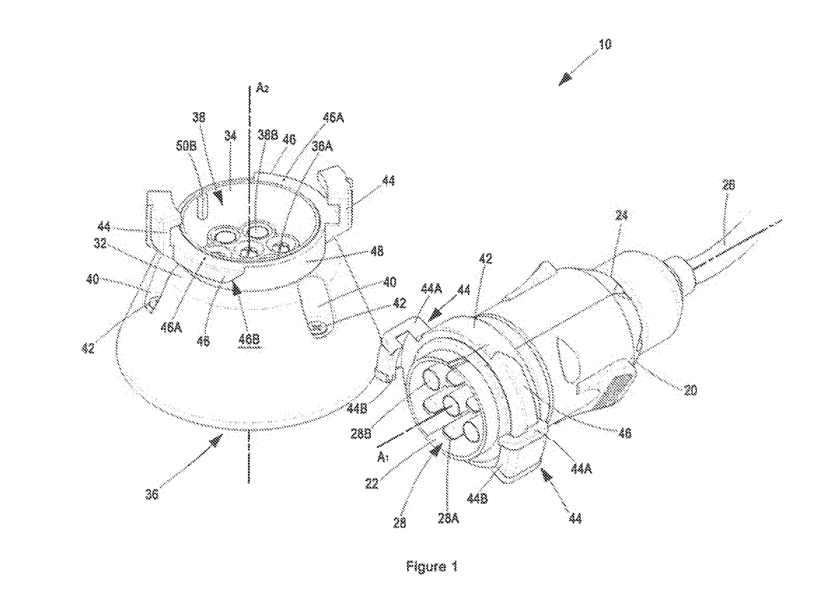

An electrical connector according to a preferred embodiment of the invention is designated generally with reference numeral 10 in FIG. 1. The electrical connector 10 comprises a plug body 20 and a socket body 32.

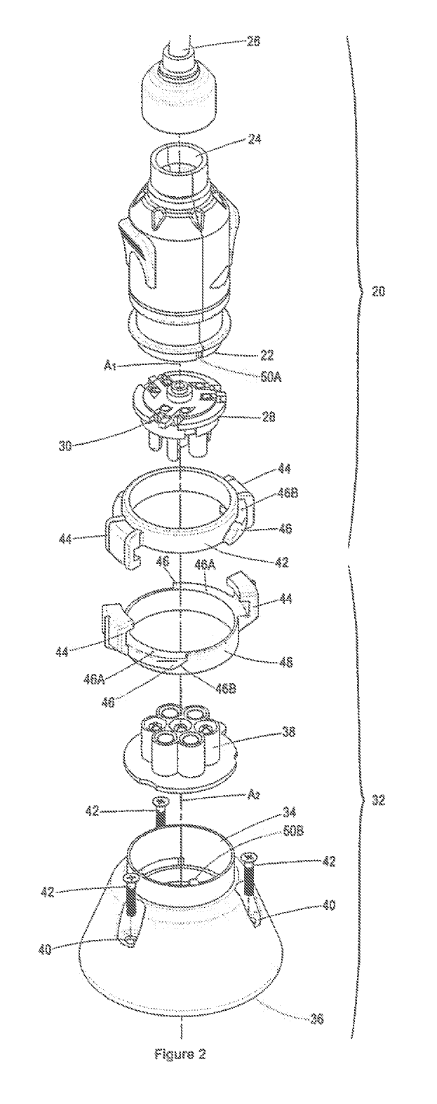

With reference now also to FIG. 2, the plug body 20 has a first connecting end 22 for connecting to the socket body 32 and an opposite second end 24 through which an electrical cable 26 is extendible.

In the preferred embodiment of the invention depicted in the accompanying figures, the plug body 20 is substantially tubular and cylindrical in shape having a central axis A₁ passing there through.

The plug body 20 houses a first electrical connector 28 therein, which first electrical connector 28 is located in the plug body 20 nearer to the first connecting end 22 than to the second end 24 thereof.

It will be appreciated that although the first electrical connector 28 is illustrated in the figures as being made up of a combination of electrical prongs 28A and prong receiving apertures 28B arranged in a substantially circular configuration about the central axis A₁, the first electrical connector 28 may be made up of only electrical prongs or only prong receiving apertures.

It will be appreciated further that individual wires (not shown) contained within the electrical cable 26 are electrically connectable to respective electrical contacts 30 on the first electrical connector 28.

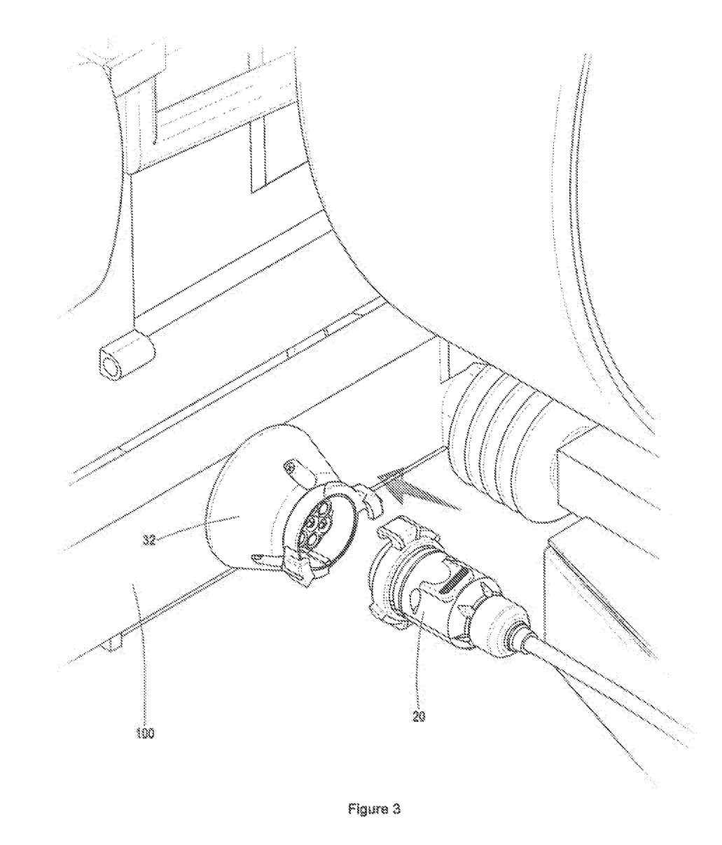

The socket body 32 similarly has a first connecting end 34 for connecting to the plug body 20 and an opposite second end 36 for mounting the socket body 32 to an object such as a vehicle 100 as illustrated in FIG. 3.

Although not shown, the second end 36 of the socket body 32 is adapted to enable an electrical cable (not shown) from the vehicle 100 to pass there through for the purposes of electrically connecting individual wires contained within such electrical cable to be electrically connected to electrical contacts of a second electrical connector 38 housed in the socket body 32.

As illustrated in the accompanying figures and particularly in FIG. 1, the second electrical connector 38 is located nearer the first connecting end 34 than to the second end 36 thereof and is made up of a combination of electrical prongs 38A and prong receiving apertures 38B arranged in a substantially circular configuration about a central axis A₂ thereof.

In the preferred embodiment of the invention depicted in the accompanying figures, the socket body 32 is substantially tubular and frustoconical in shape having mounting formations in the form of a plurality of apertures 40 each sized and shaped for receiving a fastener 42 there through for fastening the socket body 32 to the vehicle 100.

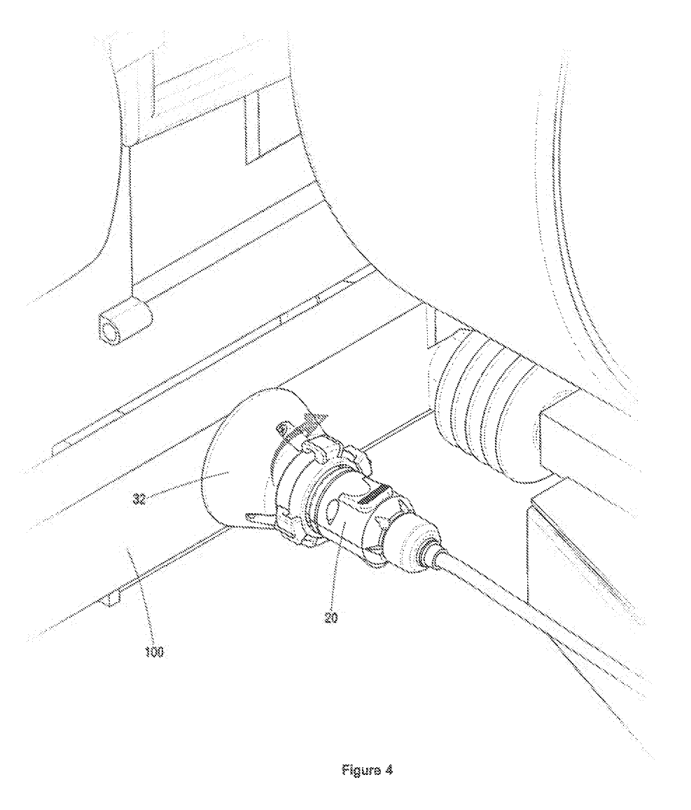

Although a reverse configuration may apply, it is preferable that the plug body 20 is a male connector and the socket body 32 is a female connector. In use, with the plug and socket bodies 20, 32 co-axially aligned within one another, the first male connecting end 22 of the plug body 20 is receivable within the first female connecting end 34 of the socket body 32 thereby to enable the electrical prongs 28A, 38A and prong receiving apertures 28B, 38B of the first and second connectors 28, 38 to engage thereby to electrically connect the plug body 20 with the socket body 32 in a connected condition as illustrated in FIG. 4.

The crux of the present invention lies in the manner in which the plug body 20 and the socket body 32 are releasably locked to one another in the connected condition, which will now be described in detail.

The plug body 20 has mounted thereon a first locking body 42. The first locking body 42 is preferably ring shaped and captured on the plug body 20 near a first connecting end 22 thereof such that the first locking body 42 is axially and rotatably movable relative to the plug body 20.

Although it is conceivable that the invention may work with the first locking body 42 having just a single first locking formation 44, it is preferable that the first locking body 42 comprises at least a pair of diametrically opposing first locking formations 44 each made up of a post 44A extending axially from one end from the plug body 20 towards the first connecting end 22 thereof, and having at an opposite free end thereof a radially inwardly extending locking overhang 44B.

In this manner, and when viewed in a plane substantially parallel to the central axes A₁, A₂, the first locking formations are substantially r- or c-shaped.

The socket body has a second locking formation 46, preferably a pair of second locking formations 46 located at or near the first connecting end 34 of the socket body 32 and positioned diametrically opposite one another there about.

The second locking formations 46 are each protrusions extending radially outwardly from the socket body 32 extending at least partially about the circumference thereof. The second locking formations 46 comprise a first surface 46A facing axially outwardly from the first connecting end 34 of the socket body 32 and a second surface 46B facing the second end 36 of the socket body 32.

It will be appreciated that in use with the plug and socket bodies 20, 32 in the connected condition, the first locking body is axially movable relative to the plug body 20 such that the locking overhangs 44A of the first locking formations 44 thereof extend beyond the second locking formations 46 of the socket body 32.

In this position, a twist action imparted between the first locking body 44 and the connected plug and socket bodies 20, 32 causes the locking overhangs 44A to engage the respective second surfaces 46B of the second locking formations 46 thereby locking the connected plug and socket bodies 20, 32 to one another as illustrated in FIG. 4.

It will be appreciated that a reverse configuration may apply wherein the first locking body 42 may be movably mounted on the socket body 32 with the second locking formations 46 located on the plug body 20. Alternatively, the first locking formations 44 on the first locking body 42 may be in the form of radially outwardly extending locking formations with the second locking formations 46 being in the form of axially extending post 44 formations.

Having said that, it is preferable that second locking formations 46 are located on a second ring-shaped locking body 48 being fixed on the socket body 32.

More preferably, both the first locking body 42 and the second locking body 48 are the same or similar, each comprising first locking formations 44 and second locking formations 46. It will be appreciated that for the first and second locking formations 44, 46 of the first and second locking bodies 42, 48 to be engageable, the first locking formations 44 on the socket body 32 must extend axially beyond the first connecting end 34 thereof.

Most preferably, at least portions of the second surfaces 46B of the second locking formations 46 are tapered towards the first connecting ends 22, 34 of the respective plug of socket bodies 20, 32 on which they are located such that as the locking overhangs 44A ride along such second surfaces 46B of the second locking formations 46 on the application of a twist action imparted to the electrical connector 10, the plug and socket bodies 20, 32 are axially drawn toward one another.

The plug and socket bodies 20, 32 further include locating formations 50A, 50B for locating such bodies 20, 32 relative to one another in only a single orientation such that the correct electrical prongs 28A, 38A engage the correct prong receiving apertures 28B, 38B.

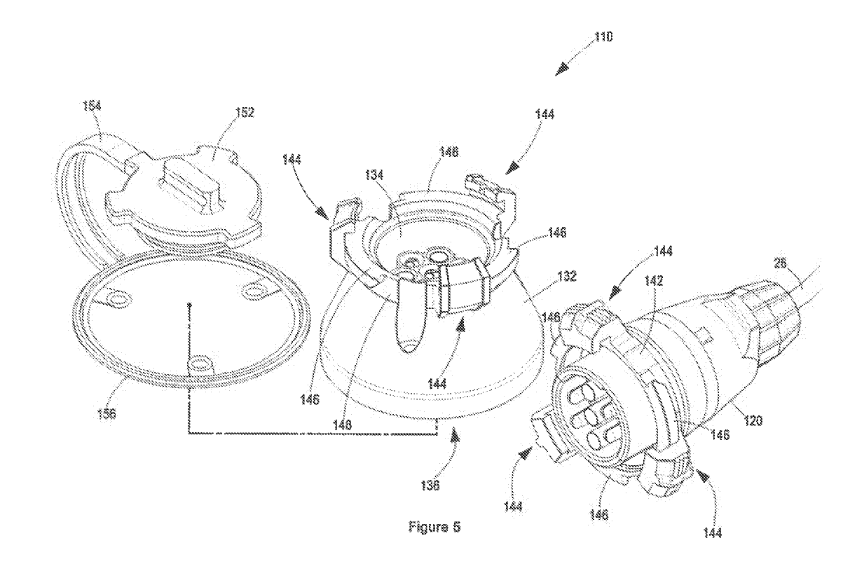

FIG. 5 illustrated an alternative embodiment of the electrical connector 110, with like references designating like parts. It will be appreciated that this alternative embodiment of the electrical connector 110 differs from the electrical connector 10 illustrated in FIG. 1 to 4 in mainly two manners.

The first difference is that instead of incorporating a pair of substantially diametrically opposing first locking formations 44 and second locking formation 46 on the first locking body 42 and the second ring-shaped locking body 48 on the respective plug body 20 and socket body 32, the electrical connector 110 of this alternative embodiment incorporates three such first locking formations 144 and second locking formation 146, substantially spaced from one another about the respective first and second locking bodies, 142, 148 by about 120 degrees.

It is envisaged that the use of three such first and second locking formations 144, 146 will better secure the plug body 120 and the socket body 132 when connected to one another.

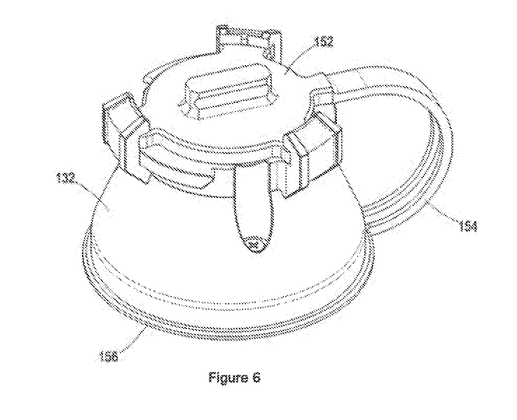

The second difference is the incorporation onto at least the socket body 132 of a dust cap 152 for closing the first connecting end 134 of the socket body 132 when the plug and socket bodies 120, 132 are note connected, as illustrated in FIG. 6.

Although the dust cap 152 may be loose, it is preferable that dust cap is tethered by a tethering arm 154 to a fasting ring 156, which fasting ring 156 is securable in use sandwiched between the second end 136 of the socket body 132 and the object 100 to which is it mountable.

Although the invention has been described above with reference to preferred embodiments, it will be appreciated that many modifications or variations of the invention are possible without departing from the spirit or scope of the invention.

For example, the electrical connector 10, 110 may further include:
a seal member (not shown) on the plug body 20 and/or the socket body 32 for sealing an internal cavity co-operatively formed by the connected plug and socket bodies 20, 32 from an outer environment; and
dust caps for closing both the the first connecting ends of the each of the plug and socket bodies 20, 120; 32, 132 in a condition other than the connected condition.

Although it is envisaged at this stage that the towing application will be the primary application of this invention, it will be appreciated that the invention may be applied to many other applications.

1. An electrical connector including:
a plug body having a first end, a second end and a central axis extending through such first and second ends, wherein the plug body houses a first electrical connector therein that is located nearer the first connecting end than to the second end of the plug body;
a socket body having a first end, a second end and a central axis extending through such first and second ends, wherein the socket body houses a second electrical connector therein that is located nearer the first connecting end than to the second end of the socket body such that the first connecting ends of the plug and socket bodies are co-axially engageable with one another to bring the first and second electrical connectors into electrical connection with one another in a connected condition;
a first locking body movably mounted on the plug body or the socket body, the first locking body having at least a first locking formation defined thereon; and
at least a second locking formation on the other of the plug body or the socket body, wherein:
(i) the first or the second locking formation extends axially from the respective plug or socket body in the direction of the first connecting end thereof, and comprises a free end having a radially inwardly extending locking overhang; and
(ii) the other of the first or the second locking formation is a protrusion extending radially from the other of the respective plug or socket body and at least partially about the circumference thereof, the radial protrusion having a first surface facing the first connecting end and a second oppositely facing surface;
such that in the connected condition and with the locking overhang extending beyond the radial protrusion, a twist action imparted between the first locking body and the connected plug and socket bodies causes the locking overhang to engage the second surface of the radial protrusion thereby locking the connected plug and socket bodies to one another.

2. An electrical connector according to claim 1, wherein;
(i) the first electrical connector or the second electrical connector is made of one or more electrical prongs, and the other of the first electrical connector or the second electrical connector is made of one or more electrical prong receiving holes in which the electrical prongs are receivable; or
(ii) the first electrical connector and the second electrical connector are each made up of a combination of electrical prongs and electrical prong receiving holes in which the electrical prongs are receivable.

3. (canceled)

4. An electrical connector according to claim 2, wherein the electrical prongs and the electrical prong receiving holes are arranged about the central axis of the respective plug and socket bodies in a substantially circular configuration.

5. An electrical connector according to claim 4, wherein at least the first connecting end of the plug body is substantially tubular with a second end thereof defining an aperture through which a wire cable comprising a plurality of individual wires is receivable into the plug body, the individual wires being connectible to at least one of: (i) the electrical prongs of the first electrical connector; and (ii) the electrical prong receiving holes of the first electrical connector.

6. An electrical connector according to claim 5, wherein at least the first connecting end of the socket body is tubular with a second end thereof: (i) comprising mounting formations for mounting the socket body to an object; and (ii) being adapted to enable a wire cable to pass there through thereby to connect individual wires thereof to at least one of: (i) the electrical prongs of the second electrical connector; and (ii) the electrical prong receiving holes of the second electrical connector.

7. An electrical connector according to claim 6, wherein the mounting formations are a plurality of apertures each sized and shaped for receiving a fastener there through for fastening the socket body to the object.

8. An electrical connector according to claim 7, wherein the first locking body is ring shaped and captured near a first connecting end of the plug or the socket body, the first locking body being axially and rotatably movable relative to the plug or the socket body.

9. An electrical connector according to claim 8, wherein the first locking formation is a combination of:
(i) at least a pair of axially extending primary locking posts located on the first locking body substantially diametrically opposite one another, wherein free ends of the primary locking posts comprise radially inwardly extending locking overhangs; and
(ii) at least a pair of radially extending primary locking protrusions located on the first locking body substantially diametrically opposite one another, each being substantially adjacent one of the respective primary locking posts and having a first surface facing the first connecting end and a second oppositely facing surface.

10. An electrical connector according to claim 9, wherein the primary locking posts are three primary locking posts spaced angularly with respect to one another by about 120 degrees, and further wherein the primary locking protrusions are three primary locking protrusions spaced angularly with respect to one another by about 120 degrees.

11. An electrical connector according to claim 10, wherein the second locking formation is a combination of:
(i) at least a pair of axially extending secondary locking posts located on the other of the plug or the socket body substantially diametrically opposite one another, wherein free ends of the secondary locking posts comprise radially inwardly extending locking overhangs; and
(ii) at least a pair of radially extending secondary locking protrusions located on the same body as the body on which the secondary locking posts are located, the secondary locking protrusions being substantially diametrically opposite one another with each being substantially adjacent one of the respective secondary locking posts and having a first surface facing the first connecting end and a second oppositely facing surface;
such that in the connected condition and with a twist action imparted between the first locking body and the connected plug and socket bodies, the locking overhangs of the primary locking posts engage the second surfaces of the secondary locking protrusions whereas the locking overhangs of the secondary locking posts engage the second surfaces of the primary locking protrusions thereby to lock the connected plug and socket bodies to one another.

12. An electrical connector according to claim 11, wherein the secondary locking posts are three secondary locking posts spaced angularly with respect to one another by about 120 degrees, and further wherein the secondary locking protrusions are three secondary locking protrusions spaced angularly with respect to one another by about 120 degrees.

13. An electrical connector according to claim 12, wherein the first locking body is located on the plug socket and the second locking formation is located on the socket body.

14. An electrical connector according to claim 13, wherein the primary and the secondary locking posts together with the respective overhangs thereof are r-shaped or c-shaped claws in a plane parallel to the central axes of the plug and socket bodies, and further wherein the free ends of the secondary locking posts extend axially beyond the first connecting end of the socket body.

15. An electrical connector according to claim 14, wherein the second locking formation is defined on a second ring-shaped locking body located near the first connecting end of the socket body.

16. An electrical connector according to claim 15, wherein the second locking body is substantially the same as the first locking body and fixed in position at the first connecting end of the socket body

17. An electrical connector according to claim 16, wherein at least portions of the second surfaces of the primary and secondary locking protrusions taper towards the first connecting end of the respective plug or socket body such that the twist action operatively imparted causes the plug and socket bodies to be axially drawn toward one another.

18. An electrical connector according to claim 17, wherein at least one of the plug body and the socket body comprise a seal member therein for in the connected condition sealing an internal cavity co-operatively formed by the connected plug and socket bodies from an outer environment.

19. An electrical connector according to claim 18, wherein the plug body is a male connector and the socket body is a female connector, the male plug body being at least partially insertable into the female socket body in the connected condition.

20. An electrical connector according to claim 19 including dust caps engageable with the first connecting ends of the each of the plug and socket bodies in a condition other than the connected condition.

21. An electrical connector according to claim 20, wherein the plug and socket bodies comprise correspondingly engageable locating formations for locating such bodies relative to one another in a single orientation such that the correct electrical prongs engage the correct prong receiving apertures.
